(19) United States
(12) Patent Application Publication
(10) Pub. No.: US 2013/0117371 A1
(43) Pub. Date: May 9, 2013

(54) APPARATUS FOR TRANSMITTING SCHEDULED MESSAGES CLASSIFIED BY TRANSMISSION MODE

(71) Applicant: Ki-Rock Kim, Seoul (KR)

(72) Inventor: Ki-Rock Kim, Seoul (KR)

(21) Appl. No.: 13/667,901

(22) Filed: Nov. 2, 2012

(30) Foreign Application Priority Data
Nov. 3, 2011 (KR) 10-2011-0114053

(51) Int. Cl. G06F 15/16

(52) U.S. Cl. 709/204

(57) ABSTRACT

An apparatus for transmitting a scheduled message classified by a transmission mode. The scheduled message is sent to a receiver via an optimized transmission mode that is automatically selected from among various transmission modes including an email, a text or multimedia message, a messenger service, a social networking service, and the like, so that it is possible to achieve effective message transmission.

### CROSS-REFERENCE TO RELATED APPLICATION(S)

This application claims the benefit under 35 U.S.C. §119(a) of Korean Patent Application No. 10-2011-0114053, filed on Nov. 3, 2011, in the Korean Intellectual Property Office, the entire disclosure of which is incorporated herein by reference for all purposes.

### BACKGROUND

1. Field

The following description relates to a technique for transmitting a scheduled message, and more particularly, to an apparatus for transmitting a scheduled message classified by a transmission mode.

2. Description of the Related Art

Korean Patent Registration No. 10-0361171 (registered on Nov. 1, 2002) discloses that a system for transmitting a message on schedule includes a server that receives at least one message and conditions for scheduled-transmission from a terminal connected with a communication network, searches for a message according to the conditions for scheduled transmission and sends the found message to the terminal.

With the development of Internet information technologies, various forms of interpersonal communication means, such as an email, a text or multimedia message, a messenger service, and a social networking service, have been introduced.

In general message communications between individuals, a sender manually selects a transmission means from among the various forms of transmission methods so as to send a message to a receiver, and thus it may be inconvenient to those who want to send a large amount of message to many individuals for the business purpose.

Therefore, there is an increasing need for a technique for effective message transmission by scheduling messages to be sent via an automatically selected optimal message transmission method.

### RELATED ART DOCUMENTS

### Patent Documents

1. Korean Patent Registration No. 10-0361171 (registered on Nov. 1, 2002)

### SUMMARY

The following description relates to an apparatus for transmitting a scheduled message via an optimal transmission mode automatically selected from among various message transmission modes.

In one general aspect, there is provided an apparatus for transmitting a scheduled message classified by transmission mode, the apparatus including: a message registering unit configured to store and register message information including message data, receiver information, and a desired transmission time in a message information database; a message control unit configured to search for the message information according to an order of desired transmission time included in the message information registered in the message information DB; a transmission mode selecting unit configured to search user information DB for a user corresponding to receiver information included in each of the message information found by the message control unit according to the order of desired transmission time and select at least one of message transmission modes included in information about the found user; a message scheduling unit configured to schedule transmission of the message information on the basis of individual transmission modes of each message information by storing the message information in a message schedule DB, wherein the message transmission mode for the message has been selected by the transmission mode selecting unit; and a message transmitting unit configured to transmit message data included in the message information scheduled by the message scheduling unit to a receiver at a desired transmission time via the message transmission mode selected by the transmission mode selecting unit.

Other features and aspects may be apparent from the following detailed description, the drawings, and the claims.

### BRIEF DESCRIPTION OF THE DRAWINGS

FIG. 1 is a block diagram illustrating an apparatus for transmitting scheduled messages classified by a transmission mode according to an exemplary embodiment of the present invention.

FIG. 2 is a table showing an example of weights for message transmission modes.

FIG. 3 is tables showing an example of setting weight values on each transmission mode of a sender side.

FIG. 4 is tables showing an example of setting weight values on each transmission mode of a receiver side.

FIG. 5 is a flowchart illustrating procedures of the apparatus for scheduled message transmission via an optimal message transmission mode.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

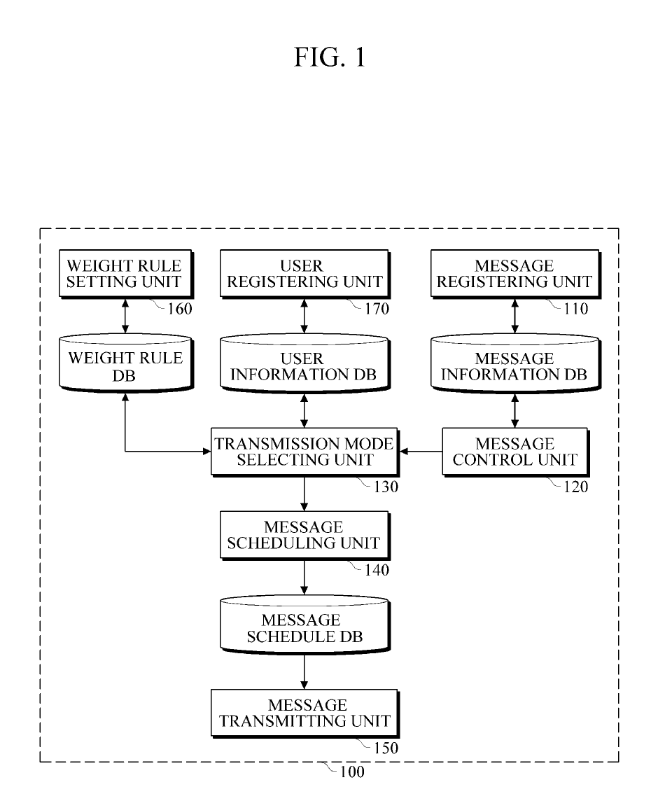

FIG. 1 is a block diagram illustrating an apparatus for transmitting scheduled messages classified by a transmission mode according to an exemplary embodiment of the present invention. Referring to FIG. 1, the apparatus 100 may include a message registering unit 110, a message control unit 120, a transmission mode selecting unit 130, a message scheduling unit 140, and a scheduled-message transmitting unit 150.

The message registering unit 110 may store and register message information in a message information database (DB). The message information may include message data containing a message title and content, receiver information, such as receiver identification information, and desired transmission time at which to transmit a message.

For example, the message registering unit 110 may provide a user interface through which to receive the message information from a message sender and store and register the received information in the message information DB.

The message control unit 120 may search for pieces of message information according to the order of desired transmission time included in the message information present in the message information DB. For the scheduled transmission of a message, a large amount of message information registered by the message registering unit 110 may be arranged in advance in the order of the desired transmission time, and then sent at the desired transmission time.

To this end, the message control unit 120 may analyze desired message-transmission time field of the registered message information, search the message information DB for message information according to the order of desired transmission time contained in the message information and retrieve the found message information.

The transmission mode selecting unit 130 may search for a user from a user information DB based on receiver information included in the message information found by the message control unit 120, and select at least one of transmission mode contained in information about the found user.

The transmission mode selecting unit 130 may select only one or more message transmission modes. Selecting two or more transmission modes may be advantageous in that the probability of the receiver being unable to receive the message can be reduced because even when one of transmission modes is temporarily or permanently unavailable, the message still can be sent to the receiver using the other transmission mode.

The message transmission modes may include a variety of means to electronically communicate messages between individuals, including an email, a text or multimedia message, a messenger service, such as MSN messenger, KakaoTalk®, and NateOn messenger, a social networking service such as Twitter®, Facebook®, me2 day®, and C Log®.

For example, the transmission mode selecting unit 130 may calculate a weight assigned to each message transmission mode included in the user information according to weight rules, and select at least one message transmission mode having a higher weight. In this example, the weight rules may reflect both weight assigned to each transmission mode of a sender side and weight assigned to each transmission mode of a receiver side.

The weight assigned to each transmission mode of a sender side may be represented as a function with respect to at least one message transmission weight factor including a message transmission speed, safety of message transmission, message transmission cost and a desired message-transmission time.

The weight assigned to each transmission mode of a receiver side may be represented as a function with respect to at least one message reception weight factor including message transmission mode preference, a non-contactable time during which not to receive a message, and a receiver's location.

For example, when it is given that a message transmission weight function with respect to the message transmission weight factor t and a transmission mode x is S(x, t) and a message reception weight function is R(x, t), a weight arithmetic expression of the transmission mode x with respect to the message transmission weight factor t may be represented as F(x, t)=S(x, t)*(x, t).

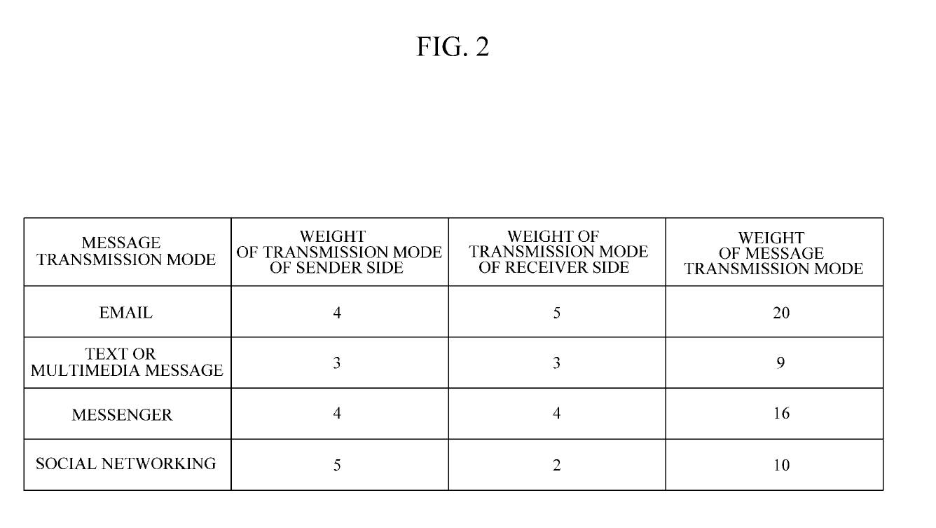

FIG. 2 is a table showing an example of weights for message transmission modes. The table illustrated in FIG. 2 has a field of message transmission modes, a field of weights assigned to each transmission mode of a sender side, a field of weights assigned to each transmission mode of a receiver side, and a field of weights assigned to each message transmission mode. Because the weight assigned to an email mode is the maximum value as shown in FIG. 2, the transmission mode selecting unit 130 may automatically select email as a means for scheduled transmission of a message.

The message scheduling unit 140 may schedule transmission of the message information, for which the transmission mode has been determined by the transmission mode selecting unit 130, on the basis of individual transmission modes of each message information by storing the message information in a message schedule DB.

In response to the transmission mode selecting unit 130 selecting the message transmission mode of each of the pieces of message information found by the message control unit 120 according to the order of the desired transmission time, the message scheduling unit 140 schedules the transmission of the message information by storing the message information in the message schedule DB, and thereby the message information is ready for transmission.

The message transmitting unit 150 may send, to the receiver, message data included in the message information that has been scheduled for transmission by the message scheduling unit 140 at the desired transmission time with the use of the transmission mode selected by the transmission mode selecting unit 130.

The message registered by the message sender can be sent on schedule via the optimal transmission mode that is automatically selected from among various transmission modes including an email, a text or multimedia message, a messenger service, and a social network service, so that it is possible to achieve effective transmission of message.

In another example, the apparatus 100 may further include a weight rule setting unit 160. The weight rule setting unit 160 may set weight rules. The weight rules may include weights of transmission modes of a sender side and weights of transmission modes of a receiver side.

For example, the weight rule setting unit 160 may provide user interfaces for a sender and for a receiver to set weights for each transmission mode, and set the weight rules based on information input through the user interfaces.

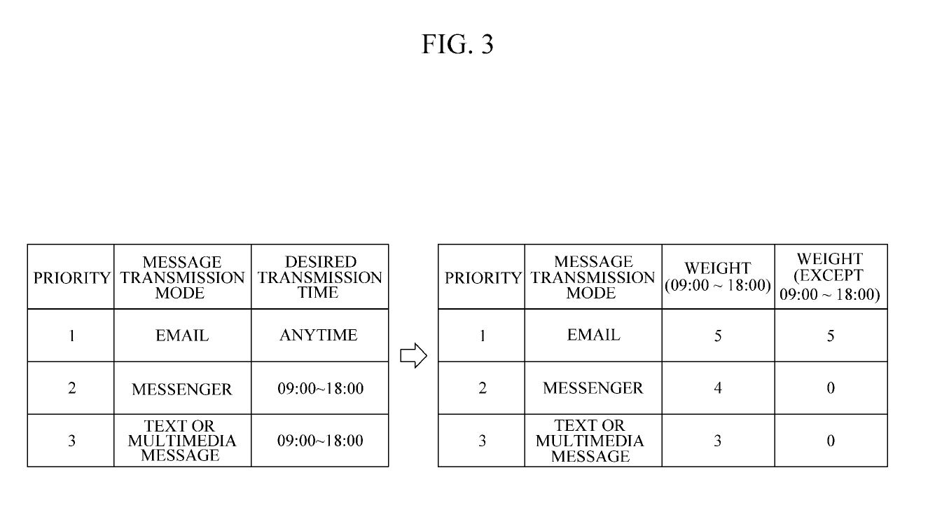

FIG. 3 illustrates tables showing an example of setting weight values on each transmission mode of a sender side. Referring to FIG. 3, the message sender gives the first priority to email, the second priority to a messenger, and the third priority to a text message service (SMS), and sets the weights according to the priorities. The right-side table in FIG. 3 shows examples of weights assigned to each transmission mode of a sender side calculated by a transmission mode selecting unit.

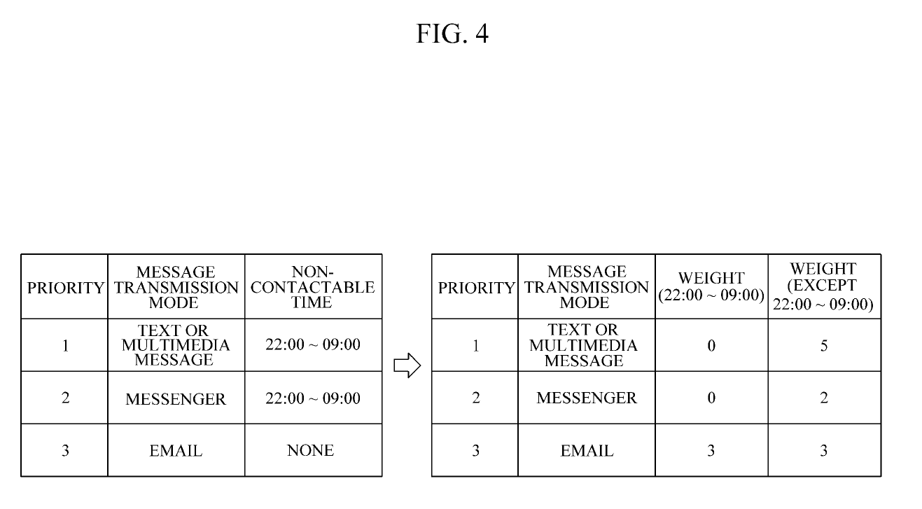

FIG. 4 illustrates tables showing an example of setting weight values on each transmission mode of a receiver side. Referring to FIG. 4, a message receiver gives the first priority to SMS, the second priority to email, and the third priority to a messenger service, and sets the weights for each transmission mode. The right-side table of FIG. 4 shows examples of weights of each transmission mode of a receiver side calculated by a transmission mode selecting unit.

In another example, the apparatus 100 may further include a user registering unit 170. The user registering unit 170 may store and register user information in a user information DB. The user information may include first user identification information necessary for using a scheduled message transmission service, information about transmission modes that the apparatus 100 is employing, and second user identification information necessary for transmitting a scheduled message via each transmission mode.

For example, the user registering unit 170 may provide a user interface for a user to input the user information, and receive the user information through the user interface, wherein the user information includes, as described above, the first user identification information necessary for using a scheduled message transmission service, the information about transmission modes that the apparatus 100 is employing, and the second user identification information necessary for transmitting a scheduled message via each transmission mode.

For example, the first user identification information may be a scheduled message transmission service subscriber ID, and the information about the transmission modes may be selected from an email, a text or multimedia message service, a messenger service, such as MSN messenger, KakaoTalk®, and NateOn® messenger, and a social networking service such as Twitter®, Facebook®, me2 day®, C Log®, and the like.

For example, the second user identification information necessary for transmitting a message may be an email address, a phone number, an access ID, or the like. The email address may be used for transmission via email, MSN messenger, Facebook, and the like, the phone number may be used for transmission via a text or multimedia message service, KakaoTalk® messenger, and the like, and the access ID may be required for transmission via NateOn® messenger, Twitter®, me2 day®, C Log.

In addition, the user registering unit 170 may set a non-contactable time during which to avoid receiving a message, thereby restricting message reception.

In this case, if the desired message-transmission time falls within the non-contactable time, the message scheduling unit 140 may adjust the scheduled time so that the message can be transmitted after the non-contactable time has passed. Thus, the receiver can avoid feeling uncomfortable due to a message received at unwanted time because the message is not received during the non-contactable time.

In another exemplary embodiment, the transmission mode selecting unit 130 may search for user information corresponding to the first user identification information from the user information DB wherein the first user identification information has been registered as receiver information by the message registering unit 110, and select at least one of message transmission modes contained in the found user information.

That is, in the above example, when registering a message, the message registering unit 110 receives the first user identification information required for using a scheduled message transmission service and registers the first user identification information as message information, and when selecting a message transmission mode, the transmission mode selecting unit 130 selects at least one from among message transmission modes registered by the user corresponding to the first user identification information.

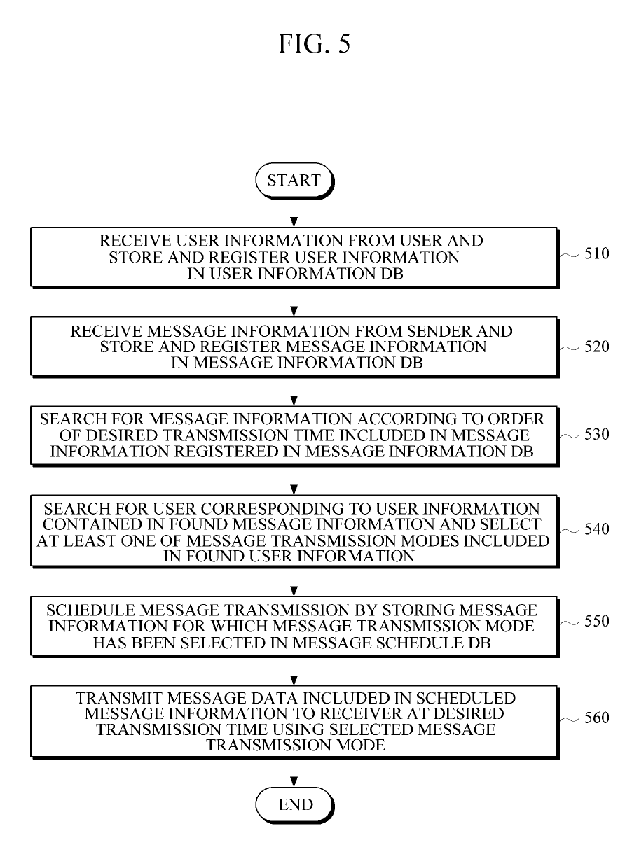

Hereinafter, operation of the apparatus for scheduled message transmission will be described with reference to FIG. 5. FIG. 5 is a flowchart illustrating procedures of the apparatus for scheduled message transmission via an optimal message transmission mode.

Referring to FIG. 5, in operation 510, the apparatus receives user information from a user and stores and registers the received user information in a user information DB, wherein the user information includes first user identification information necessary for using a scheduled message transmission service, information about transmission modes that the apparatus is employing, and second user identification information necessary for transmitting a scheduled message via each transmission mode.

In operation 520, the apparatus receives message information from a message sender and store and registers the received message information which includes message data including the message title and content, receiver information, and a desired transmission time. In this case, the first user identification information may be received as receiver information.

Then, in operation 530, the apparatus searches for and retrieves message information according to desired message-transmission time included in the message information registered in the message information DB.

In operation 540, the apparatus searches user information DB for a user corresponding to receiver information included in each of the found message information, and selects at least one of message transmission modes included in the found user information. The operation of selecting the message transmission mode is described above, and thus will not be reiterated.

Thereafter, in operation 550, the apparatus schedules message transmission by storing the message information for which the message transmission mode has been selected in a message schedule DB.

In operation 560, the apparatus transmits message data included in each of the scheduled message information to a receiver at the desired transmission time via the selected message transmission mode.

Accordingly, a message that has been registered by a message sender is scheduled transmitted to a receiver by an optimal transmission mode that is automatically selected from among various message transmission modes including an email, a text or multimedia message, a messenger, and a social networking service, and thus it is possible to achieve effective message transmission.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for transmitting a scheduled message classified by transmission mode, the apparatus comprising:
a message registering unit configured to store and register message information including message data, receiver information, and a desired transmission time in a message information database;
a message control unit configured to search for the message information according to an order of desired transmission time included in the message information registered in the message information DB;
a transmission mode selecting unit configured to search user information DB for a user corresponding to receiver information included in each of the message information found by the message control unit according to the order of desired transmission time and select at least one of message transmission modes included in information about the found user;
is a message scheduling unit configured to schedule transmission of the message information on the basis of individual transmission modes of each message information by storing the message information in a message schedule DB, wherein the message transmission mode for the message has been selected by the transmission mode selecting unit; and
a message transmitting unit configured to transmit message data included in the message information scheduled by the message scheduling unit to a receiver at a desired transmission time via the message transmission mode selected by the transmission mode selecting unit.

2. The apparatus of claim 1, wherein the transmission mode selecting unit is configured to calculate weights of each of the message transmission modes included in the user information based on weight rules and select the at least one message transmission mode having a higher weight.

3. The apparatus of claim 2, wherein the weight rules are set to include weights of transmission modes of a sender side and weights of transmission modes of a receiver side.

4. The apparatus of claim 3, wherein the weights of transmission modes of a sender side is represented as a function with respect to at least one message transmission weight factor including a message transmission speed, safety of message transmission, message transmission cost and a desired message-transmission time.

5. The apparatus of claim 3, wherein the weights of transmission modes of a receiver side is represented as a function with respect to at least one message reception weight factor including message transmission mode preference, a non-contactable time during which not to receive a message, and a receiver's location.

6. The apparatus of claim 2, further comprising:
a weight rule setting unit configured to set the weight rules.

7. The apparatus of claim 1, further comprising:
a user registering unit configured to store and register user information in a user information DB wherein the user information includes first user identification information necessary for using a scheduled message transmission service, information about transmission modes that the apparatus is employing, and second user identification information necessary for transmitting a scheduled message via each transmission mode.

8. The apparatus of claim 7, wherein the transmission mode selecting unit is configured to search the user information DB for the user corresponding to the first user identification information registered as receiver information by the message registering unit and select the at least one message transmission mode from among the message transmission modes included in the information about the found user corresponding to the first user identification information.

9. The apparatus of claim 5, wherein the message scheduling unit is configured to, if a desired message-transmission time falls within the non-contactable time, adjust a scheduled transmission time so as to transmit a scheduled message after the non-contactable time.

10. The apparatus of claim 1, wherein the message transmission modes include an email, a text or multimedia message, a messenger service, and a social networking service.
